(19) United States
(12) Patent Application Publication
(10) Pub. No.: US 2026/0065157 A1
(43) Pub. Date: Mar. 5, 2026

(54) DATA ANALYSIS APPARATUS, METHOD, AND NON-TRANSITORY COMPUTER-READABLE STORAGE MEDIUM

(71) Applicant: KABUSHIKI KAISHA TOSHIBA, Kawasaki-shi (JP)

(72) Inventors: Shuhei NITTA, Tokyo (JP); Yasutaka FURUSHO, Fuchu Tokyo (JP)

(73) Assignee: KABUSHIKI KAISHA TOSHIBA, Kawasaki-shi (JP)

(21) Appl. No.: 19/311,572

(22) Filed: Aug. 27, 2025

(30) Foreign Application Priority Data
Sep. 4, 2024 (JP) 2024-152294

(51) Int. Cl. G06N 20/00; G06F 18/23

(52) U.S. Cl. CPC G06N 20/00; G06F 18/23

(57) ABSTRACT

According to one embodiment, a data analysis apparatus includes processing circuitry. The processing circuitry acquires a plurality of items of subject data, trains a first training model by performing unsupervised learning on the items of subject data using a first data augmentation condition that is a condition related to a data augmentation conversion method, and generates a plurality of first feature vectors corresponding to the items of subject data, generates a first clustering result by clustering the first feature vector, trains a second training model by performing unsupervised learning on the items of subject data using a second data augmentation condition, and generate a plurality of second feature vectors corresponding to the items of subject data, and generates a comparison result by comparing the first feature vectors and the second feature vectors for each of a plurality of clusters based on the first clustering result.

### CROSS-REFERENCE TO RELATED APPLICATIONS

This application is based upon and claims the benefit of priority from Japanese Patent Application No. 2024-152294, filed Sep. 4, 2024, the entire contents of which are incorporated herein by reference.

### FIELD

Embodiments described herein relate generally to a data analysis apparatus, method, and a non-transitory computer-readable storage medium BACKGROUND Conventionally, in a training method of machine learning, unsupervised learning in which a machine learning model trains a feature of subject data without giving a classification label as correct data is known. In this unsupervised learning, since the classification label is unknown, the subject data may be classified into the number of clusters reflecting the feature of the subject data. However, there is a case where subject data having different characteristics tend to be classified into the same cluster, and there is a possibility that it is difficult to interpret a clustering result.

### BRIEF DESCRIPTION OF THE DRAWINGS

FIG. 1 is a block diagram illustrating a configuration of a data analysis apparatus according to an embodiment.

FIG. 2 is a block diagram illustrating a specific configuration of a first training unit in FIG. 1.

FIG. 3 is a flowchart illustrating an operation of the data analysis apparatus according to the embodiment.

FIG. 4 is a diagram illustrating a first specific example of subject data in the embodiment.

FIG. 5 is a diagram illustrating a second specific example of subject data in the embodiment.

FIG. 6 is a diagram illustrating a third specific example of subject data in the embodiment.

FIG. 7 is a diagram illustrating a fourth specific example of subject data in the embodiment.

FIG. 8 is a flowchart illustrating a specific example of first training processing of the flowchart of FIG. 3.

FIG. 9 is a flowchart illustrating a specific example of second training processing of the flowchart of FIG. 3.

FIG. 10 is a diagram illustrating a specific example of a display image including a scatter diagram visualizing a plurality of first feature vectors according to the embodiment.

FIG. 11 is a diagram illustrating a first specific example of a display image including a scatter diagram visualizing a plurality of second feature vectors according to the embodiment.

FIG. 12 is a diagram illustrating a second specific example of a display image including a scatter diagram visualizing a plurality of second feature vectors according to the embodiment.

FIG. 13 is a diagram illustrating a first specific example of a comparison result according to the embodiment.

FIG. 14 is a diagram illustrating a second specific example of the comparison result according to the embodiment.

FIG. 15 is a diagram illustrating another specific example of a display image including a scatter diagram according to the embodiment.

FIG. 16 is a block diagram illustrating a hardware configuration of a computer according to an embodiment.

### DETAILED DESCRIPTION

In general, according to one embodiment, a data analysis apparatus includes processing circuitry. The processing circuitry acquires a plurality of items of subject data, trains a first training model by performing unsupervised learning on the items of subject data using a first data augmentation condition that is a condition related to a data augmentation conversion method, and generates a plurality of first feature vectors corresponding to the items of subject data, generates a first clustering result by clustering the plurality of first feature vector, trains a second training model by performing unsupervised learning on the items of subject data using a second data augmentation condition having a condition regarding the conversion method different from the first data augmentation condition, and generate a plurality of second feature vectors corresponding to the items of subject data, and generates a comparison result by comparing the plurality of first feature vectors and the plurality of second feature vectors for each of a plurality of clusters based on the first clustering result.

Hereinafter, embodiments of a data analysis apparatus will be described in detail with reference to the drawings.

### Embodiment

In the present embodiment, image data including a figure will be described as data to be analyzed (hereinafter, referred to as subject data). In addition, a data analysis apparatus uses a training model of machine learning in which these images are clustered for each type of figure by unsupervised learning. As the machine learning, for example, a deep neural network (DNN) is used. That is, the training model of the embodiment is a DNN model.

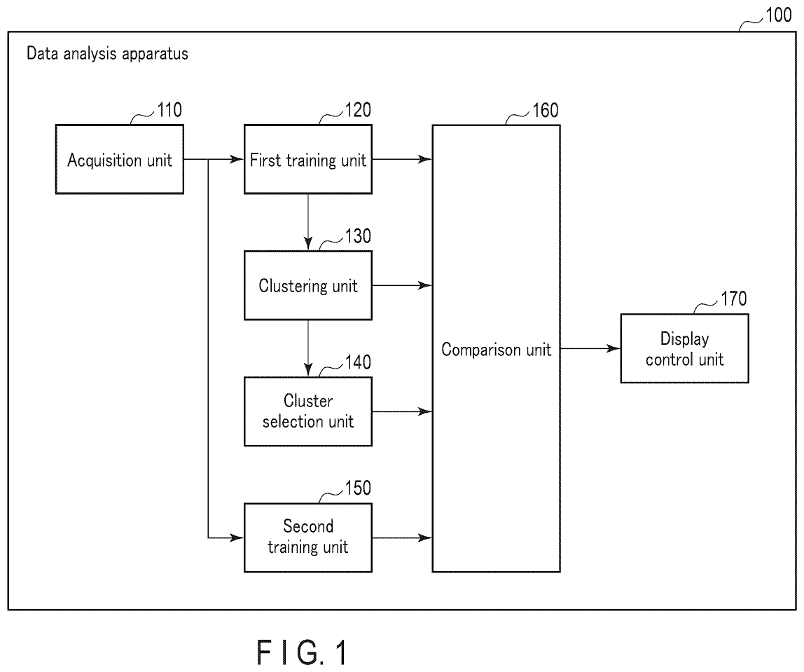

FIG. 1 is a diagram illustrating a configuration example of a data analysis apparatus according to an embodiment. A data analysis apparatus 100 in FIG. 1 includes an acquisition unit 110, a first training unit 120, a clustering unit 130, a cluster selection unit 140 (selection unit), a second training unit 150, a comparison unit 160, and a display control unit 170.

The acquisition unit 110 acquires a plurality of items of subject data. The acquisition unit 110 outputs the plurality of items of subject data to the first training unit 120 and the second training unit 150.

The subject data is, for example, image data including figures such as a circle, a triangle, and a quadrangle. In a specific example of the embodiment, the image data is, for example, a color image having an image size of 32×32 pixels. That is, the subject data is a vector data group of a 3072 dimensional vector of 32×32×3 (RGB values). Note that the subject data may be referred to as training data.

Furthermore, the acquisition unit 110 may acquire a first training condition and a second training condition. At this time, the acquisition unit 110 outputs the first training condition to the first training unit 120 and outputs the second training condition to the second training unit 150. Hereinafter, an outline of the training condition common to the first training condition and the second training condition will be described.

The above training condition includes, for example, a model structure, a structure parameter, a loss function, an optimization parameter, and the like of the DNN. Examples of the model structure of DNN include ResNet, MobileNet, and EfficientNet specialized for image classification. The structure parameter includes, for example, the number of network layers, the number of nodes in each layer, a connection method between the layers, and the type of activation function used in each layer. Examples of the loss function include a simple framework for contrastive learning of visual representations (SimCLR), Bootstrap Your Own Latent (BYOL), and Brlow Twins. The optimization parameter includes, for example, an optimizer type (Momentum Stochastic Gradient Descent (SGD), Adam (Adaptive moment estimation) etc.),
a learning rate (or a learning rate schedule), the number of updates (the number of times of iterative training), the number of mini-batches (mini-batch size), and the strength of WeightDecay. In addition, the training condition includes a data augmentation condition to be described later.

The first training unit 120 receives a plurality of items of subject data from the acquisition unit 110. The first training unit 120 trains (iteratively trains) the first machine learning model under the first training condition using the plurality of items of subject data. The first training condition includes a first data augmentation condition to be described later. The first training unit 120 outputs a plurality of first feature vectors by inputting a plurality of items of subject data to a first trained model that is a first machine learning model for which training has been completed. The first training unit 120 outputs the plurality of first feature vectors to the clustering unit 130 and the comparison unit 160.

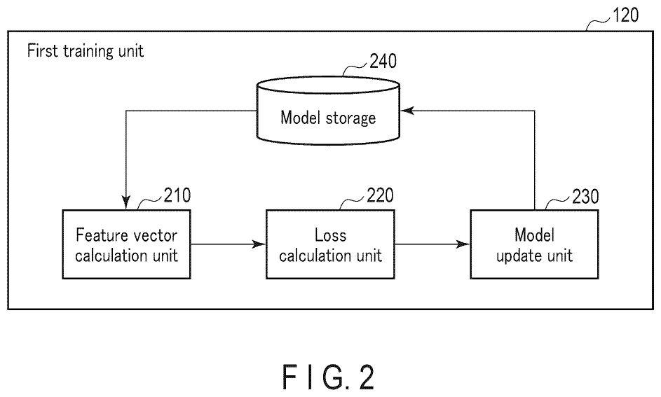

Furthermore, in a case where the acquisition unit 110 has acquired the first training condition, the first training unit 120 may receive the first training condition from the acquisition unit 110. Furthermore, the first training unit 120 may set a first training condition for training of the first machine learning model. Hereinafter, a specific configuration of the first training unit 120 will be described with reference to FIG. 2.

FIG. 2 is a block diagram illustrating a specific configuration of the first training unit in FIG. 1. The first training unit 120 in FIG. 2 includes a feature vector calculation unit 210, a loss calculation unit 220, a model update unit 230, and a model storage 240. In each of the following units, processing of one subject data of the plurality of items of subject data will be described.

The feature vector calculation unit 210 calculates the first feature vector based on the subject data. Specifically, the feature vector calculation unit 210 outputs (calculates) the first feature vector by inputting the subject data to the first machine learning model stored in the model storage 240. The feature vector calculation unit 210 outputs the calculated first feature vector to the loss calculation unit 220. Note that, in the present embodiment, the first feature vector is, for example, 128 dimensional vector data output from an output layer of the DNN.

Note that the feature vector calculation unit 210 outputs the first feature vector output from the output layer of the DNN in the calculation of the loss by training of the first machine learning model. On the other hand, after training the first machine learning model, the feature vector calculation unit 210 may output the output of an intermediate layer before the output layer (for example, several layers before the output layer) as the first feature vector.

The loss calculation unit 220 receives the first feature vector from the feature vector calculation unit 210. The loss calculation unit 220 calculates a loss using the first feature vector. The loss calculation unit 220 outputs the loss to the model update unit 230.

In the present embodiment, in the calculation of the loss, data augmentation used to improve training accuracy of unsupervised learning is used. Examples of a data augmentation conversion method for the image data used in the present embodiment include scaling, image rotation, and monochrome inversion. The above-described first data augmentation condition is a condition related to a data augmentation conversion method set by the first training unit 120. In addition, the model structure and the structure parameters of the DNN used in the first training unit 120 are set by the first training condition. Hereinafter, a specific example of unsupervised learning using data augmentation will be described.

The loss calculation unit 220 calculates the loss using SimCLR, which is one of unsupervised learning methods, for example. The loss L using SimCLR can be obtained by, for example, the following Expressions (1) and (2).

$$ℓ ( i , j ) = - log \frac{exp ( sim ( {z}_{i} , {z}_{j} ) / τ )}{{\sum }_{k = 1}^{2 N} {1}_{[ k \neq i ]} exp ( sim ( {z}_{i} , {z}_{k} ) / τ )} \qquad ( 1 )$$

$$L = \frac{1}{2 N} {\sum }_{k = 1}^{N} [ ℓ ( 2 k - 1 , 2 k ) + ℓ ( 2 k , 2 k - 1 ) ] \qquad ( 2 )$$

In Expression (1), N represents the number of subject data used for loss calculation (corresponding to the mini-batch size in a case where stochastic optimization is performed), and i and j represent serial numbers of two types of samples augmented from the same subject data by data augmentation. In SimCLR, since two kinds of samples obtained by data augmentation from one piece of subject data are used, the total number of samples is 2N.

Further, an indication function 1_{[k≠i]} represents a function that becomes 1 in the case of k≠i and becomes 0 in other cases, and sim (A, B) represents a function (for example, a cosine function) that outputs a larger numerical value as the similarity between A and B is higher. Further, z represents an output vector (feature vector) of the DNN, a subscript (for example, i, j, and k) of z represents a serial number of the subject data, and τ represents a temperature parameter related to a loss. The temperature parameter τ can balance the sensitivity of the numerical value output by the sim function, and is set such that the smaller the value, the higher the sensitivity, and the larger the value, the lower the sensitivity.

In other words, the loss calculation unit 220 calculates the loss using a method (for example, SimCLR) in which the smaller the error between two different feature vectors obtained from the same subject data and the larger the error between two different feature vectors obtained from different subject data, the smaller the loss.

The model update unit 230 receives the loss from the loss calculation unit 220. The model update unit 230 updates the parameters of the machine learning model using the loss. The model update unit 230 outputs the updated parameters of the machine learning model to the model storage 240.

Specifically, the model update unit 230 applies the loss-based optimization parameter to the machine learning model to update the parameter of the machine learning model. The optimization parameter is set by the first training condition.

The model storage 240 receives the parameters of the machine learning model from the model update unit 230. The model storage 240 stores the machine learning model updated based on the parameter.

Briefly, the first training unit 120 iteratively trains a first machine learning model (first training model) by performing unsupervised learning on a plurality of items of subject data using a first data augmentation condition that is a condition regarding a data augmentation conversion method, and generates a plurality of first feature vectors corresponding to the plurality of items of subject data.

The clustering unit 130 receives the plurality of first feature vectors from the first training unit 120. The clustering unit 130 generates a first clustering result by clustering a plurality of first feature vectors. The clustering unit 130 outputs the first clustering result to the cluster selection unit 140 and the comparison unit 160.

As a clustering method, for example, K-Means clustering is used. The clustering unit 130 clusters a plurality of first feature vectors using, for example, the K-Means method to generate first clustering results of any number of clusters. Any number of clusters may be designated by the user or may be designated by using a cluster number estimation technique, for example. Examples of the cluster number estimation technique include an elbow method and silhouette analysis.

The first clustering result includes, for example, a cluster number which is an ID of a cluster to which the first feature vector belongs. Specifically, the first clustering result includes, for example, data in which the first feature vector and the cluster number are associated with each other. Furthermore, for example, the first clustering result may include data in which the first feature vector, the subject data corresponding to the first feature vector, and the cluster number are associated with each other.

In addition, the clustering unit 130 may assign a cluster label corresponding to the cluster number. The assignment of the cluster label includes, for example, manual assignment by a user and automatic assignment using machine learning or the like. In the manual assignment, a user checks data (image) included in a cluster, and assigns, for example, a cluster label indicating a feature of the image to each cluster. In the automatic assignment, images included in a cluster are analyzed using machine learning or the like, and a cluster label is automatically assigned. Therefore, the first clustering result may include data in which the first feature vector and the cluster label are associated with each other. In addition, the first clustering result may include data in which the first feature vector, subject data corresponding to the first feature vector, and a cluster label are associated with each other.

The cluster selection unit 140 receives the first clustering result from the clustering unit 130. The cluster selection unit 140 selects one or more clusters among the plurality of clusters included in the first clustering result. The cluster selection unit 140 outputs information (selected cluster information) on the one or more selected clusters to the comparison unit 160.

Note that the cluster selection unit 140 may determine an upper limit of the cluster to be selected. For example, the cluster selection unit 140 may select one or more clusters less than the plurality of clusters from among the plurality of clusters included in the first clustering result.

The second training unit 150 receives a plurality of items of subject data from the acquisition unit 110. The second training unit 150 trains (iteratively trains) the second machine learning model under the second training condition using the plurality of subject data. The second training condition includes a second data augmentation condition to be described later. The second training unit 150 outputs a plurality of second feature vectors by inputting a plurality of items of subject data to a second trained model that is a second machine learning model for which training has been completed. The second training unit 150 outputs the plurality of second feature vectors to the comparison unit 160.

Furthermore, in a case where the acquisition unit 110 has acquired the second training condition, the second training unit 150 may receive the second training condition from the acquisition unit 110. In addition, the second training unit 150 may set a second training condition for training the second machine learning model. Note that, as a specific configuration of the second training unit 150, a configuration substantially similar to that of the first training unit 120 illustrated in FIG. 2 may be used, and thus description thereof is omitted.

The above-described second data augmentation condition is a condition related to a data augmentation conversion method set by the second training unit 150. In addition, the second data augmentation condition is different from the first data augmentation condition in the condition regarding the conversion method.

As a specific example in which the conditions regarding the conversion method are different, the set of conversion methods configuring the second data augmentation condition is a subset of the set of conversion methods configuring the first data augmentation condition.

As another specific example, the first data augmentation condition and the second data augmentation condition each include a set of the same conversion methods, and have different parameters related to the degree of conversion associated with one or more conversion methods of the set.

Note that, in a case of focusing on the clustering result caused by the difference in the data augmentation condition, it is effective to make the conditions (for example, model structure and structure parameters) other than the data augmentation condition the same in the first training condition and the second training condition. In other words, the first training condition and the second training condition may differ only in the data augmentation condition.

Briefly, the second training unit 150 iteratively trains the second machine learning model (second training model) by performing unsupervised learning on the plurality of items of subject data using the second data augmentation condition having a different condition regarding the conversion method from the first data augmentation condition, and generates a plurality of second feature vectors corresponding to the plurality of items of subject data.

The comparison unit 160 receives a plurality of first feature vectors from the first training unit 120, receives a first clustering result from the clustering unit 130, receives selected cluster information from the cluster selection unit 140, and receives a plurality of second feature vectors from the second training unit 150. The comparison unit 160 generates a comparison result by comparing a plurality of first feature vectors and a plurality of second feature vectors for each of a plurality of clusters based on the first clustering result. The comparison unit 160 outputs the comparison result to the display control unit 170.

Specifically, for example, the comparison unit 160 calculates a dispersion degree (first dispersion degree) of each of the plurality of first feature vectors included in the cluster to be compared and a dispersion degree (second dispersion degree) of each of the plurality of second feature vectors included in the cluster to be compared, and generates a comparison result including the first dispersion degree and the second dispersion degree. The cluster to be compared is, for example, a cluster included in the selected cluster information. Therefore, the comparison unit 160 may generate a comparison result for each of one or more selected clusters.

Furthermore, for example, the comparison unit 160 calculates a difference between the first dispersion degree and the second dispersion degree, and generates a comparison result including the difference in dispersion degree. That is, the comparison result may include at least one of the first dispersion degree and the second dispersion degree related to the selected cluster and the difference in dispersion degree between the first dispersion degree and the second dispersion degree. Note that the comparison result may include at least one of information on the selected cluster and information on the data augmentation condition.

The dispersion degree is calculated using, for example, a standard deviation, a variance, a sum of differences between the sample pairs of the feature vectors, and a maximum range of the distribution of the clusters with respect to the feature vector in the cluster to be compared. In addition, in a case where the dispersion degree of the cluster is small, it indicates that the samples in the cluster get together, and in a case where the dispersion degree of the cluster is large, it indicates that the samples in the cluster are dispersed.

Furthermore, the comparison unit 160 may generate the second clustering result regarding the plurality of second feature vectors based on the first clustering result and the plurality of second feature vectors. As a result, the comparison unit 160 may generate a comparison result by comparing the first clustering result with the second clustering result. The second clustering result includes, for example, a cluster number used in the first clustering result. Specifically, the second clustering result includes, for example, data in which the second feature vector and the cluster number are associated with each other. In addition, the second clustering result may include data in which the second feature vector and the cluster label are associated with each other. Furthermore, subject data corresponding to the second feature vector may be further associated with the second clustering result.

Furthermore, the comparison unit 160 may generate a scatter diagram in order to visualize the clustering result. Specifically, the comparison unit 160 uses a dimension reduction method such as PCA, t-SNE, and UMAP to represent the feature vectors by a plurality of different components, and generates a scatter diagram in which each point of the feature vector is grouped for each cluster based on a clustering result. In a case where there are two different components, the comparison unit 160 generates a two-dimensional scatter diagram. In a case where the number of different components is three, the comparison unit 160 generates a three-dimensional scatter diagram. The grouping means, for example, distinguishing each cluster. For example, the comparison unit 160 generates a scatter diagram that can identify each cluster by displaying coordinate points corresponding to feature vectors in different colors and shapes for each cluster.

The display control unit 170 receives the comparison result from the comparison unit 160. The display control unit 170 displays the comparison result on the display, for example. Furthermore, for example, the display control unit 170 may display a display image including a scatter diagram in which at least one of the plurality of first feature vectors and the plurality of second feature vectors is represented by a plurality of different components, and each point of the feature vectors is grouped for each cluster based on the first clustering result. The display image may include, for example, a scatter diagram and display information related to the scatter diagram. The display information is, for example, at least one of a type of display data (for example, the type of feature vector) included in the scatter diagram, a type of a conversion method included in the data augmentation condition, and a representative image of each cluster. Note that the display control unit 170 may display the comparison result and the display image.

The data analysis apparatus 100 may include a memory and a processor. The memory stores, for example, various programs (for example, the data analysis program) related to the operation of the data analysis apparatus 100. The processor reads and executes various programs stored in the memory, thereby implementing the functions of the acquisition unit 110, the first training unit 120, the clustering unit 130, the cluster selection unit 140, the second training unit 150, the comparison unit 160, and the display control unit 170.

In addition, the data analysis apparatus 100 does not need to be physically configured by one computer, and may be configured by a computer system (for example, a data analysis system) including a plurality of computers communicably connected via a wired or network line or the like. The assignment of the series of processing according to the embodiment to a plurality of processors mounted on a plurality of computers can be optionally set. All the processors may execute all the processing in parallel, or specific processing may be assigned to one or some of the processors, and a series of processing according to the embodiment may be executed as the entire computer system. Typically, an external computer may play the roles of the first training unit 120 and the second training unit 150 in the embodiment.

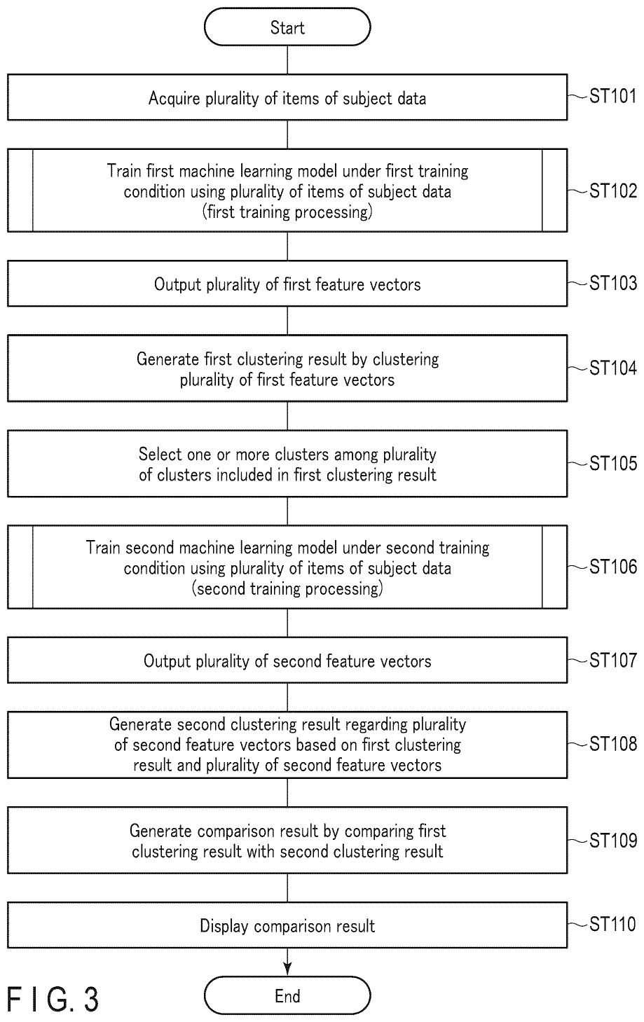

The configuration of the data analysis apparatus 100 according to the embodiment has been described above. Next, the operation of the data analysis apparatus 100 according to the embodiment will be described with reference to a flowchart of FIG. 3.

FIG. 3 is a flowchart illustrating an operation of the data analysis apparatus according to the embodiment. The processing of the flowchart of FIG. 3 is started, for example, if a data analysis program is selected by the user and the data analysis program is executed by the processor.

### (Step ST101)

The acquisition unit 110 acquires a plurality of items of subject data. Hereinafter, it is assumed that the subject data is image data including any of a circle, a triangle, and a quadrangle. Hereinafter, a specific example of the subject data will be described with reference to FIGS. 4 to 7.

FIG. 4 is a diagram illustrating a first specific example of subject data in the embodiment. A first specific example is an image including a black circle. FIG. 4 illustrates an image BC-1, an image BC-2, images BC-3, . . . , and an image BC-n1 as variations of the image including the black circle. Note that n1 is the total number of items of image data including black circles.

FIG. 5 is a diagram illustrating a second specific example of subject data in the embodiment. A second specific example is an image including a black triangle. FIG. 5 illustrates an image BT-1, an image BT-2, images BT-3, . . . , and an image BT-n2 as variations of the image including the black triangle. Note that n2 is the total number of items of image data including black triangles.

FIG. 6 is a diagram illustrating a third specific example of subject data in the embodiment. A third specific example is an image including a white quadrangle. FIG. 6 illustrates an image WR-1, an image WR-2, images WR-3, . . . , and an image WR-n3 as variations of the image including the white quadrangle. Note that n3 is the total number of items of image data including the white quadrangle.

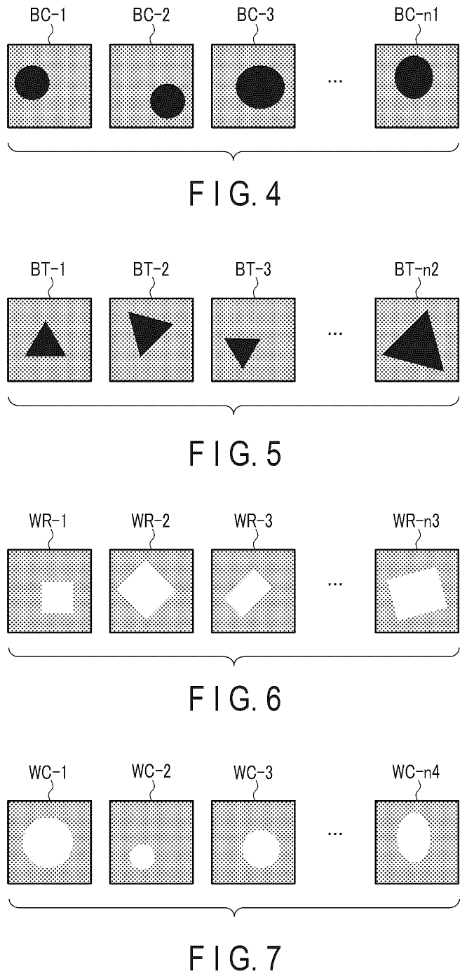

FIG. 7 is a diagram illustrating a fourth specific example of subject data in the embodiment. A fourth specific example is an image including a white circle. FIG. 7 illustrates an image WC-1, an image WC-2, images WC-3, . . . , and an image WC-n4 as variations of images including white circles. Note that n4 is the total number of items of image data including white circles.

In the following description, it is assumed that the plurality of items of subject data includes a mixture of the items of image data described in the first to fourth specific examples. In addition, an object of the data analysis apparatus 100 is to classify these items of image data for each type.

### (Step ST102)

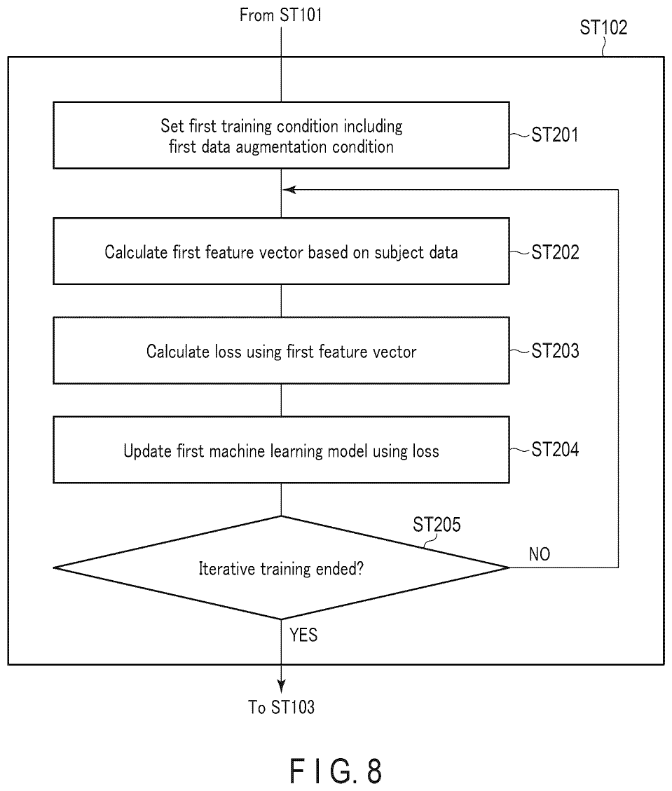

After the acquisition unit 110 acquires the plurality of subject data, the first training unit 120 trains the first machine learning model under the first training condition using the plurality of subject data. Hereinafter, the processing of step ST102 is referred to as “first training processing”. Hereinafter, a specific example of the first training processing will be described with reference to the flowchart of FIG. 8.

FIG. 8 is a flowchart illustrating a specific example of the first training processing of the flowchart of FIG. 3. The flowchart of FIG. 8 transitions from step ST101 of the flowchart of FIG. 3.

### (Step ST201)

After the acquisition unit 110 acquires the plurality of items of subject data, the first training unit 120 sets the first training condition including the first data augmentation condition. As a specific example below, the first data augmentation condition includes three conversion methods of “scaling”, “image rotation”, and “monochrome inversion”.

### (Step ST202)

After the first training unit 120 sets the first training condition, the feature vector calculation unit 210 calculates the first feature vector based on the subject data. Note that the subject data here is converted by the first data augmentation condition.

### (Step ST203)

After the feature vector calculation unit 210 calculates the first feature vector, the loss calculation unit 220 calculates the loss using the first feature vector.

### (Step ST204)

After the loss calculation unit 220 calculates the loss, the model update unit 230 updates the first machine learning model using the loss.

Note that it is preferable to perform “iterative training” (probabilistic optimization) by repeating the processing from step ST202 to step ST204 described above on subset data (mini-batch) randomly selected from a plurality of subject data without duplication. Further, a cycle of processing for all of the plurality of items of subject data is expressed as “one epoch”. For convenience of description, it is assumed that the processing for all the plurality of items of subject data has made a round, and the processing proceeds to step ST205.

### (Step ST205)

After the processing for all of the plurality of items of subject data has made a round, the first training unit 120 determines whether to end the iterative training. In this determination, for example, a predetermined number of epochs may be used as the end condition. In a case where it is determined not to end the iterative training, the processing returns to step ST202. In a case where it is determined to end the iterative training, the processing proceeds to step ST103.

### (Step ST103)

After the first training processing is performed, the first training unit 120 outputs a plurality of first feature vectors. Specifically, the first training unit 120 outputs a plurality of first feature vectors by inputting a plurality of items of subject data to a first trained model that is a first machine learning model for which training has been completed by the first training processing.

### (Step ST104)

After the first training unit 120 outputs the plurality of first feature vectors, the clustering unit 130 clusters the plurality of first feature vectors to generate a first clustering result.

### (Step ST105)

After the clustering unit 130 generates the first clustering result, the cluster selection unit 140 selects one or more clusters among the plurality of clusters included in the first clustering result.

### (Step ST106)

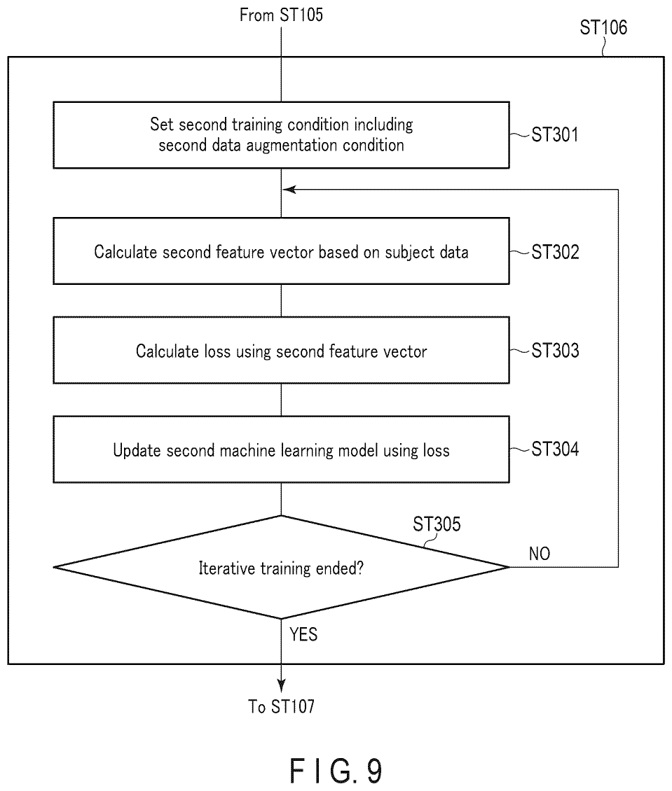

After the cluster selection unit 140 selects one or more clusters, the second training unit 150 trains the second machine learning model under the second training condition using the plurality of subject data. Hereinafter, the processing of step ST106 is referred to as “second training processing”. Hereinafter, a specific example of the second training processing will be described with reference to a flowchart of FIG. 9.

FIG. 9 is a flowchart illustrating a specific example of the second training processing of the flowchart of FIG. 3. The flowchart of FIG. 9 transitions from step ST105 of the flowchart of FIG. 3.

### (Step ST301)

After the cluster selection unit 140 selects one or more clusters, the second training unit 150 sets the second training condition including the second data augmentation condition. As a specific example below, the second data augmentation condition includes two conversion methods of “image rotation” and “scaling” or “monochrome inversion”. Specifically, the second data augmentation condition 1 and the second data augmentation condition 2 are set as variations of the second data augmentation condition. The second data augmentation condition 1 includes two conversion methods of “scaling” and “image rotation”. The second data augmentation condition 2 includes two conversion methods of “image rotation” and “monochrome inversion”.

### (Step ST302)

After setting the second training condition, the second training unit 150 calculates the second feature vector based on the subject data.

### (Step ST303)

After calculating the second feature vector, the second training unit 150 calculates a loss using the second feature vector.

### (Step ST304)

After calculating the loss, the second training unit 150 updates the second machine learning model using the loss.

Note that, to be precise, “iterative training” is performed by repeating the above processing from step ST302 to step ST304 for all of the plurality of items of subject data. For convenience of description, it is assumed that the processing for all the plurality of items of subject data has made a round, and the processing proceeds to step ST305.

### (Step ST305)

After the processing for all of the plurality of items of subject data has made a round, the second training unit 150 determines whether to perform iterative training. In this determination, for example, a predetermined number of epochs may be used as the end condition. In a case where it is determined not to end the iterative training, the processing returns to step ST302. In a case where it is determined to end the iterative training, the processing proceeds to step ST107.

### (Step ST107)

After the second training processing is performed, the second training unit 150 outputs a plurality of second feature vectors. Specifically, the second training unit 150 outputs a plurality of second feature vectors by inputting a plurality of items of subject data to a second trained model that is a second machine learning model for which training has been completed by the second training processing.

### (Step ST108)

After the second training unit 150 outputs the plurality of second feature vectors, the comparison unit 160 generates a second clustering result regarding the plurality of second feature vectors based on the first clustering result and the plurality of second feature vectors.

### (Step ST109)

After generating the second clustering result, the comparison unit 160 generates a comparison result by comparing the first clustering result with the second clustering result.

### (Step ST110)

After the comparison unit 160 generates the comparison result, the display control unit 170 displays the comparison result. Furthermore, the display control unit 170 may display a scatter diagram or the like regarding at least one of the plurality of first feature vectors and the plurality of second feature vectors. After step ST110, the processing of the flowchart of FIG. 3 ends.

Some flowcharts described above are examples. The order and the like of each step of these flowcharts may be changed as much as possible, or other steps may be added.

### (Specific Example of Display)

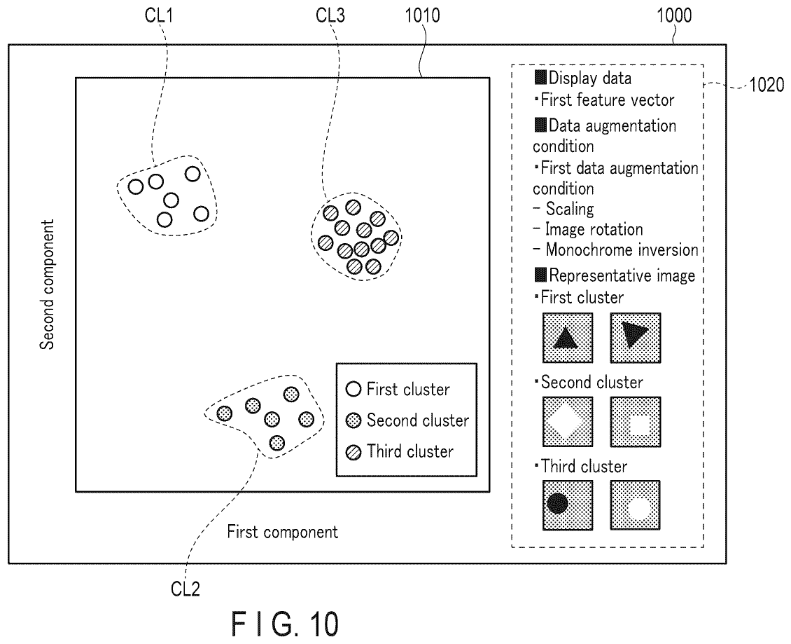

FIG. 10 is a diagram illustrating a specific example of a display image including a scatter diagram visualizing a plurality of first feature vectors according to the embodiment. A display image 1000 in FIG. 10 includes a scatter diagram 1010 and display information 1020.

In the scatter diagram 1010, a plurality of first feature vectors generated using the first data augmentation condition is represented by arbitrary first and second components. The scatter diagram 1010 includes a first cluster CL1, a second cluster CL2, and a third cluster CL3.

The display information 1020 indicates information on the scatter diagram 1010. Specifically, the display information 1020 includes display data information (first feature vector), data augmentation condition information (first data augmentation condition (“scaling”, “image rotation”, and “monochrome inversion”)), and representative image information (representative image of each of first cluster, second cluster, and third cluster).

According to FIG. 10, according to a first data augmentation condition, the image of FIG. 5 (image including black triangle) is classified in a first cluster CL1, the image of FIG. 6 (image including white square) is classified in a second cluster CL2, and the image of FIG. 4 (image including black circle) and the image of FIG. 7 (image including white circle) are classified in a third cluster CL3.

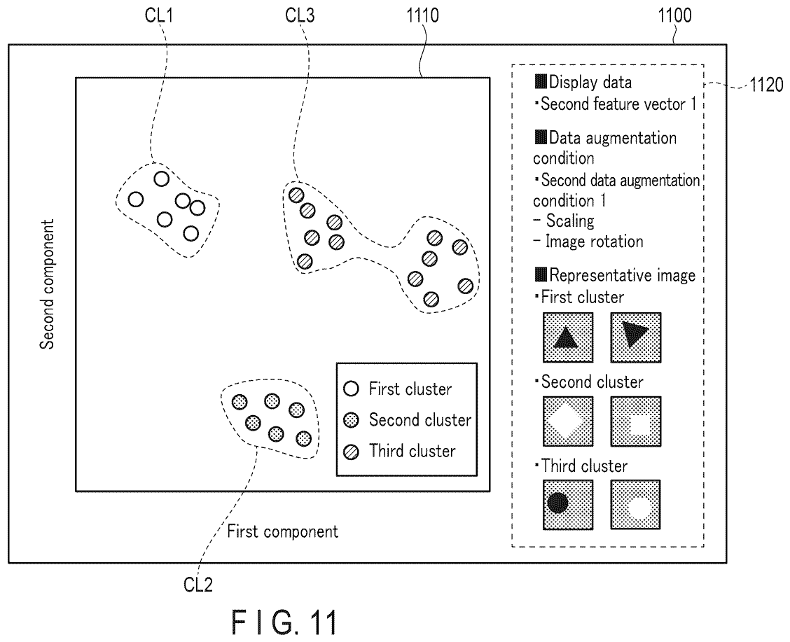

FIG. 11 is a diagram illustrating a first specific example of a display image including a scatter diagram visualizing a plurality of second feature vectors according to the embodiment. A display image 1100 in FIG. 11 includes a scatter diagram 1110 and display information 1120.

In the scatter diagram 1110, a plurality of second feature vectors 1 generated using the second data augmentation condition 1 are represented by arbitrary first and second components. The scatter diagram 1110 includes a first cluster CL1, a second cluster CL2, and a third cluster CL3.

The display information 1120 indicates information on the scatter diagram 1110. Specifically, the display information 1120 includes display data information (second feature vector 1), data augmentation condition information (second data augmentation condition 1 (“scaling” and “image rotation”)), and representative image information (representative image of each of first cluster, second cluster, and third cluster).

According to FIG. 11, according to a second data augmentation condition 1, the image of FIG. 5 (image including black triangle) is classified in the first cluster CL1, the image of FIG. 6 (image including white square) is classified in the second cluster CL2, and the image of FIG. 4 (image including black circle) and the image of FIG. 7 (image including white circle) are classified in the third cluster CL3. The reason why the type of the image included in each cluster is the same as that in FIG. 10 is that the cluster ID of the first clustering result is used for visualization of the plurality of second feature vectors 1.

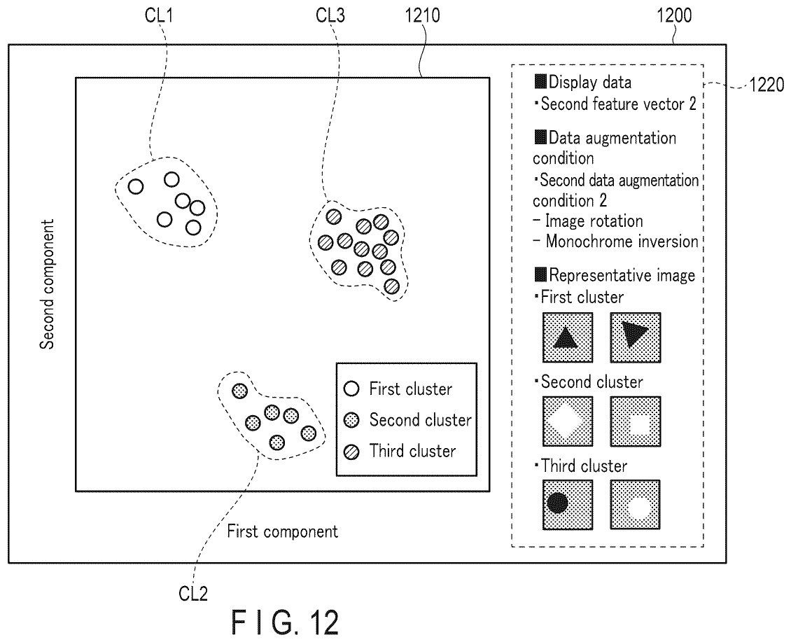

FIG. 12 is a diagram illustrating a second specific example of a display image including a scatter diagram visualizing a plurality of second feature vectors according to the embodiment. A display image 1200 in FIG. 12 includes a scatter diagram 1210 and display information 1220.

In the scatter diagram 1210, a plurality of second feature vectors 2 generated using the second data augmentation condition 2 are represented by arbitrary first and second components. The scatter diagram 1210 includes a first cluster CL1, a second cluster CL2, and a third cluster CL3.

The display information 1220 indicates information on the scatter diagram 1210. Specifically, the display information 1220 includes display data information (second feature vector 2), data augmentation condition information (second data augmentation condition 2 (“image rotation” and “monochrome inversion”)), and representative image information (representative image of each of first cluster, second cluster, and third cluster).

As can be seen from FIG. 12, according to a second data augmentation condition 2, the image of FIG. 5 (image including black triangle) is classified in the first cluster CL1, the image of FIG. 6 (image including white square) is classified in the second cluster CL2, and the image of FIG. 4 (image including black circle) and the image of FIG. 7 (image including white circle) are classified in the third cluster CL3. Note that the reason why the types of images included in each cluster are the same as those in FIG. 10 is that the cluster ID of the first clustering result is used for visualization of the plurality of second feature vectors 1, as in FIG. 11.

Here, focusing on the third cluster CL3, it can be seen that in the scatter diagrams 1010 of FIG. 10 and the scatter diagram 1210 of FIG. 12, the samples in the cluster are present in an aggregated state (that is, the dispersion degree is small), whereas in the scatter diagram 1110 of FIG. 11, the samples in the cluster are present in a dispersed state (that is, the dispersion degree is large). Further, in the scatter diagram 1110 of FIG. 11, it can be confirmed that the third cluster CL3 appears to be divided into two clusters. As can be estimated from the representative image of the third cluster CL3, the image of FIG. 4 (image including a black circle) and the image of FIG. 7 (image including a white circle) classified as the third cluster CL3 should be clustered into different clusters.

These differences are caused by different types of conversion methods included in the data augmentation condition. Specifically, the second data augmentation condition 1 is obtained by removing the conversion method of “monochrome inversion” from the first data augmentation condition, and the second data augmentation condition 2 is obtained by removing the conversion method of “scaling” from the first data augmentation condition. In the scatter diagram 1010 related to the first data augmentation condition and the scatter diagram 1210 related to the second data augmentation condition, the dispersion degree of the samples included in the third cluster CL3 is similar, and in the scatter diagram 1110 related to the second data augmentation condition 2, the dispersion degree of the samples included in the third cluster CL3 is different from the above two scatter diagrams. That is, it can be inferred that the “black-and-white reversal” of the conversion method included in the data augmentation condition is a factor of classifying the image in FIG. 4 (image including a black circle) and the image in FIG. 7 (image including a white circle), which should originally be clustered separately, into the same cluster.

Briefly, as shown in FIGS. 10 through 12, the data analysis apparatus 100 can display a scatter diagram for each of the different data augmentation conditions together with the type of conversion technique for the data augmentation condition associated with the scatter diagram. As a result, the user can confirm the state of the cluster due to the difference in the data augmentation condition as the shape of the cluster.

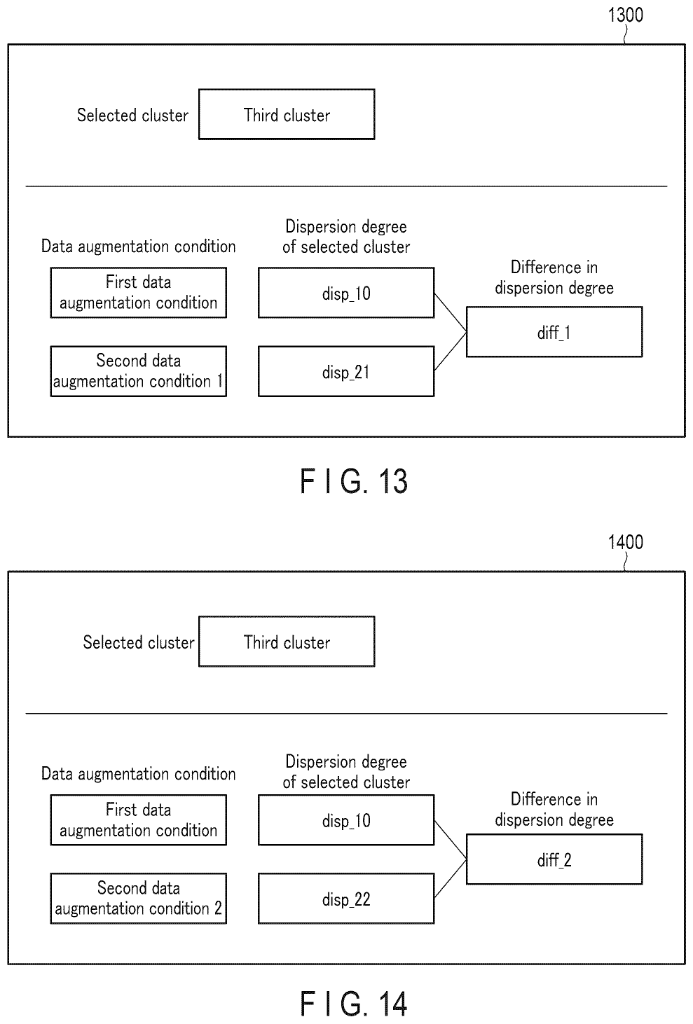

FIG. 13 is a diagram illustrating a first specific example of a comparison result in the embodiment. A comparison result 1300 of FIG. 13 includes information on the selected cluster, information on the data augmentation condition to be compared, the dispersion degree of the selected cluster corresponding to the data augmentation condition, and the difference in dispersion degree. Specifically, the comparison result 1300 indicates, for the selected third cluster, a dispersion degree “disp_10” under the first data augmentation condition, a dispersion degree “disp_21” under the second data augmentation condition 1, and a dispersion degree difference “diff_1”.

FIG. 14 is a diagram illustrating a second specific example of the comparison result in the embodiment. Similarly to FIG. 13, the comparison result 1400 of FIG. 14 includes information on the selected cluster, information on the data augmentation condition to be compared, the dispersion degree of the selected cluster corresponding to the data augmentation condition, and the difference in the dispersion degree. Specifically, the comparison result 1400 indicates, for the selected third cluster, the dispersion degree “disp_10” under the first data augmentation condition, the dispersion degree “disp_22” under the second data augmentation condition 2, and the dispersion degree difference “diff_2”.

In FIGS. 13 and 14, in a case where the dispersion degree “disp_22” is larger than the dispersion degree “disp_21”, the user can infer that the samples exist in a distributed manner in the second data augmentation condition 1 rather than in the second data augmentation condition 2 with respect to the shape of the third cluster. That is, the user can estimate that the event in which the plurality of images is classified into the third cluster is greatly affected by the conversion method (here, “black-and-white inversion”) in the second data augmentation condition 1 instead of the second data augmentation condition 2.

In addition, in a case where a difference “diff_1” in the dispersion degree is larger than a difference “diff_2” in the dispersion degree, the user can estimate that the shape of the third cluster is different in the first data augmentation condition more than the second data augmentation condition 1 than the second data augmentation condition 2. That is, the user can estimate that the influence of the conversion method (here, “black-and-white inversion”) in the first data augmentation condition but not in the second data augmentation condition 1 is large.

Briefly, as illustrated in FIGS. 13 and 14, the data analysis apparatus 100 can display, as a comparison result, a difference between the dispersion degrees of the different data augmentation conditions and the dispersion degrees of the different data augmentation conditions for a selected cluster (third cluster) that is a cluster to be compared. As a result, the user can confirm the state of the cluster due to the difference in the data augmentation condition as a numerical value.

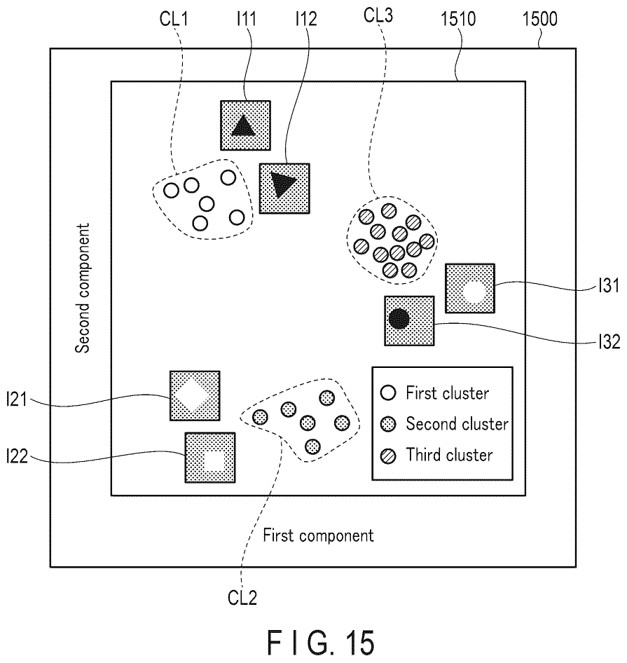

FIG. 15 is a diagram illustrating another specific example of the display image including the scatter diagram according to the embodiment. A display image 1500 of FIG. 15 includes a scatter diagram 1510.

In the scatter diagram 1510, a plurality of first feature vectors generated using the first data augmentation condition is represented by arbitrary first and second components. The scatter diagram 1510 includes a first cluster CL1, a second cluster CL2, and a third cluster CL3.

Further, in the scatter diagram 1510, a representative image is shown in the vicinity of each cluster. Specifically, in the scatter diagram 1510, a representative image Ill and a representative image 112 corresponding to the image of FIG. 5 are illustrated in the vicinity of the first cluster CL1, a representative image 121 and a representative image 122 corresponding to the image of FIG. 6 are illustrated in the vicinity of the second cluster CL2, and a representative image 131 corresponding to the image of FIG. 7 and a representative image 132 corresponding to the image of FIG. 4 are illustrated in the vicinity of the third cluster CL3.

Briefly, as shown in FIG. 15, the data analysis apparatus 100 may include a representative image of each cluster on the scatter diagram when causing a display image including the scatter diagram to be displayed. This makes it easy for the user to visually recognize the cluster shown in the scatter diagram and the representative image of the cluster.

As described above, the data analysis apparatus according to the embodiment includes acquiring a plurality of items of subject data, training a first training model by performing unsupervised learning on the plurality of items of subject data using a first data augmentation condition that is a condition related to a data augmentation conversion method, and generating a plurality of first feature vectors corresponding to the plurality of items of subject data, generating a first clustering result by clustering the plurality of first feature vectors, training a second training model by performing unsupervised learning on the plurality of items of subject data using a second data augmentation condition having a condition regarding the conversion method different from the first data augmentation condition, and generating a plurality of second feature vectors corresponding to the plurality of items of subject data, and generating a comparison result by comparing the plurality of first feature vectors and the plurality of second feature vectors for each of a plurality of clusters based on the first clustering result.

Therefore, the data analysis apparatus according to the embodiment can estimate the influence of the data augmentation on the clustering by comparing the feature vectors generated from the training models having different data augmentation conditions.

### (Modification 1)

The data analysis apparatus according to the above embodiment uses the image data as the subject data, but the present invention is not limited thereto. For example, any data such as speech data, table data, and sensor data such as acceleration and voltage may be used as the subject data.

### (Modification 2)

The data analysis apparatus according to the above embodiment uses DNN as machine learning, but the present invention is not limited thereto. For example, any machine learning model such as linear regression, multiple regression, support vector machine (SVM), and a decision tree may be used as the machine learning.

### (Modification 3)

The data analysis apparatus according to the above embodiment compares the difference in the set of conversion methods configuring each of the first data augmentation condition and the second data augmentation condition, but the present invention is not limited thereto. As described above, each of the first data augmentation condition and the second data augmentation condition may be configured by a set of the same conversion methods, and the parameters related to the degrees of conversion associated with one or more conversion methods of the set may be different.

For example, a case where three methods of “scaling”, “image rotation”, and “monochrome inversion” are set as the data augmentation condition conversion method will be described. It is assumed that the first data augmentation condition is the degree of conversion “from 0.5 times to 2.0 times magnification” associated with “scaling”, the degree of conversion “rotation angle “−180 degrees to +180 degrees” associated with “image rotation”, and the degree of conversion “reversal probability 50%” associated with “black-and-white reversal”, and that the second data augmentation condition is that the degree of conversion associated with “scaling” and “black-and-white reversal” is the same as the first data augmentation condition, and the degree of conversion “rotation angle −90 degrees to +90 degrees” associated with “image rotation”. That is, the first data augmentation condition and the second data augmentation condition are configured by a set of “scaling”, “image rotation”, and “monochrome inversion”, respectively, and have different parameters related to the degree of conversion associated with “image rotation”.

### (Modification 4)

A data analysis apparatus according to Modification 4 may train the second machine learning model by unsupervised learning of a plurality of items of subject data using a parameter of a first trained model that is a first machine learning model for which training is completed as an initial value. As a result, the data analysis apparatus according to Modification 4 can shorten the time required for training the second machine learning model.

### (Modification 5)

A data analysis apparatus according to Modification 5 may train the second machine learning model by additionally training the selected cluster using the parameter of the first trained model as an initial value. Specifically, the data analysis apparatus according to Modification 5 may cause the second machine learning model to train by additional training limited to only subject data (samples) included in the selected cluster or samples around the selected cluster with the parameter of the first trained model as an initial value. As a result, the data analysis apparatus according to Modification 5 narrows down the clusters to be processed and performs training, so that the time required for analysis can be shortened.

### (Modification 6)

A data analysis apparatus according to Modification 6 may not consider the cluster selection unit. Specifically, the data analysis apparatus according to Modification 6 may have a configuration in which the cluster selection unit is removed, or may not select a cluster in the cluster selection unit. Not selecting a cluster is synonymous with selecting all clusters. Thus, the data analysis apparatus according to Modification 6 generates a comparison result or the like for each of all clusters.

### (Modification 7)

A data analysis apparatus according to the Modification 7 may designate two different types of subject data (for example, an image BC-2 of FIG. 4 and an image WC-3 of FIG. 7) and calculate a distance between two feature vectors corresponding to the designated two different types of subject data. Accordingly, the data analysis apparatus according to Modification 7 can confirm a change in the distance between two feature vectors under different data augmentation conditions.

### (Hardware Configuration)

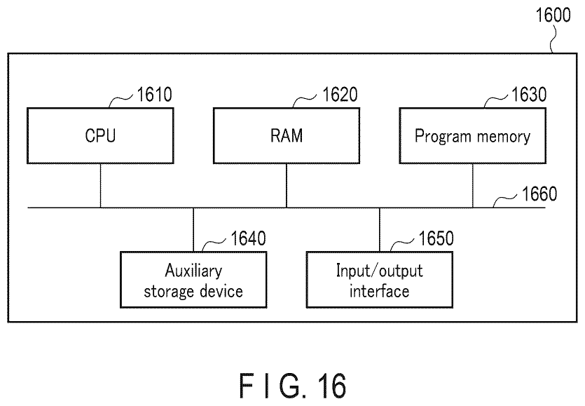

FIG. 16 is a block diagram illustrating a hardware configuration of a computer according to an embodiment. The computer 1600 includes, as hardware, a central processing unit (CPU) 1610, a random access memory (RAN) 1620, a program memory 1630, an auxiliary storage device 1640, and an input/output interface 1650. The CPU 1610 communicates with the RAM 1620, the program memory 1630, the auxiliary storage device 1640, and the input/output interface 1650 through a bus 1660.

The CPU 1610 is an example of a general-purpose processor. The RAM 1620 is used as a working memory for the CPU 1610. The RAM 1620 includes a volatile memory such as a synchronous dynamic random access memory (SDRAM). The program memory 1630 stores various programs including a data analysis program. As the program memory 1630, for example, a read-only memory (ROM), a part of the auxiliary storage device 1640, or a combination thereof is used. The auxiliary storage device 1640 non-temporarily stores data. The auxiliary storage device 1640 includes a nonvolatile memory such as an HDD or an SSD.

The input/output interface 1650 is an interface for connecting to another device. The input/output interface 1650 is used, for example, for connection or communication between the acquisition unit 110 and an external device (for example, an input/output device and a server device) illustrated in FIG. 1, connection or communication between the display control unit 170 and an external device.

Each program stored in the program memory 1630 includes a computer-executable instruction. If executed by the CPU 1610, the program (computer-executable instruction) causes the CPU 1610 to execute predetermined processing. For example, if the data analysis program is executed by the CPU 1610, the data analysis program causes the CPU 1610 to execute a series of processing described with respect to each unit of FIGS. 1 and 2.

The program may be provided to the computer 1600 in a state of being stored in a computer-readable storage medium. In this case, for example, the computer 1600 further includes a drive (not illustrated) that reads data from the storage medium, and acquires the program from the storage medium. Examples of the storage medium include a magnetic disk, an optical disk (CD-ROM, CD-R, DVD-ROM, DVD-R, and the like), a magneto-optical disk (MO or the like), and a semiconductor memory. In addition, the program may be stored in a server on the communication network, and the computer 1600 may download the program from the server using the input/output interface 1650.

The processing described in the embodiment is not limited to being performed by a general-purpose hardware processor such as the CPU 1610 executing a program, and may be performed by a dedicated hardware processor such as an application specific integrated circuit (ASIC). The term processing circuit (processing unit) includes at least one general purpose hardware processor, at least one special purpose hardware processor, or a combination of at least one general purpose hardware processor and at least one special purpose hardware processor. In the example illustrated in FIG. 16, the CPU 1610, the RAM 1620, and the program memory 1630 correspond to a processing circuit.

Therefore, according to each embodiment described above, it is possible to estimate the influence of data augmentation on clustering.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data analysis apparatus, comprising processing circuitry configure to:
acquire a plurality of items of subject data;
train a first training model by performing unsupervised learning on the items of subject data using a first data augmentation condition that is a condition related to a data augmentation conversion method, and generate a plurality of first feature vectors corresponding to the items of subject data;
generate a first clustering result by clustering the plurality of first feature vectors;
train a second training model by performing unsupervised learning on the items of subject data using a second data augmentation condition having a condition regarding the conversion method different from the first data augmentation condition, and generate a plurality of second feature vectors corresponding to the items of subject data; and
generate a comparison result by comparing the plurality of first feature vectors and the plurality of second feature vectors for each of a plurality of clusters based on the first clustering result.

2. The data analysis apparatus according to claim 1, the processing circuitry is further configured to
select one or more of the clusters included in the first clustering result, the number of clusters being less than the clusters; and
generating the comparison result for each of one or more selected clusters.

3. The data analysis apparatus according to claim 1, wherein a set of conversion methods included in the second data augmentation condition is a subset of the set of conversion methods included in the first data augmentation condition.

4. The data analysis apparatus according to claim 1, wherein the first data augmentation condition and the second data augmentation condition are configured by a set of the same conversion methods, and have different parameters related to a degree of conversion associated with one or more conversion methods of the set.

5. The data analysis apparatus according to claim 1, the processing circuitry is further configured to calculate a first dispersion degree of the plurality of first feature vectors included in a cluster to be compared and a second dispersion degree of the plurality of second feature vectors included in the cluster to be compared, and generate the comparison result including the first dispersion degree and the second dispersion degree.

6. The data analysis apparatus according to claim 5, the processing circuitry is further configured to calculate a difference between the first dispersion degree and the second dispersion degree, and generate the comparison result further including the difference in dispersion degree.

7. The data analysis apparatus according to claim 1, the processing circuitry is further configured to calculate a difference between a first dispersion degree of the plurality of first feature vectors included in a cluster to be compared and a second dispersion degree of the plurality of second feature vectors included in the cluster to be compared, and generate the comparison result including the difference in dispersion degree.

8. The data analysis apparatus according to claim 1, the processing circuitry is further configured to display the comparison result.

9. The data analysis apparatus according to claim 1, the processing circuitry is further configured to display a display image including a scatter diagram in which at least one of the plurality of first feature vectors and the plurality of second feature vectors is represented by a plurality of different components, and each point of the feature vectors is grouped for each cluster based on the first clustering result.

10. The data analysis apparatus according to claim 9, wherein
the display image further includes display information related to the scatter diagram, and
the display information is at least one of a type of display data included in the scatter diagram, a type of the conversion method included in the data augmentation condition, and a representative image of each cluster.

11. The data analysis apparatus according to claim 9, the processing circuitry is further configured to
calculate a first dispersion degree of the plurality of first feature vectors included in a cluster to be compared and a second dispersion degree of the plurality of second feature vectors included in the cluster to be compared, and generate the comparison result including the first dispersion degree and the second dispersion degree; and
display the display image and the comparison result.

12. The data analysis apparatus according to claim 11, the processing circuitry is further configured to calculate a difference between the first dispersion degree and the second dispersion degree, and generate the comparison result further including the difference in dispersion degree.

13. The data analysis apparatus according to claim 9, the processing circuitry is further configured to
calculate a difference between a first dispersion degree of the plurality of first feature vectors included in a cluster to be compared and a second dispersion degree of the plurality of second feature vectors included in the cluster to be compared, and generate the comparison result including a difference in dispersion degree; and
display the display image and the comparison result.

14. The data analysis apparatus according to claim 9, wherein the display image includes a representative image of each cluster on the scatter diagram.

15. The data analysis apparatus according to claim 1, the processing circuitry is further configured to train the second training model by performing unsupervised learning on the items of subject data using a parameter of the first training model for which training has been completed as an initial value.

16. The data analysis apparatus according to claim 2, the processing circuitry is further configured to train the second training model by performing additional training with respect to the selected one or more clusters using a parameter of the first training model for which training has been completed as an initial value.

17. The data analysis apparatus according to claim 1, the processing circuitry is further configured to
output the plurality of first feature vectors by inputting the subject data to the first training model for which training has been completed; and
output the plurality of second feature vectors by inputting the items of subject data to the second training model for which training has been completed.

18. A data analysis method, comprising:
acquiring a plurality of items of subject data;
training a first training model by performing unsupervised learning on the items of subject data using a first data augmentation condition that is a condition related to a data augmentation conversion method, and generating a plurality of first feature vectors corresponding to the items of subject data;
generating a first clustering result by clustering the plurality of first feature vectors;
training a second training model by performing unsupervised learning on the items of subject data using a second data augmentation condition having a condition regarding the conversion method different from the first data augmentation condition, and generating a plurality of second feature vectors corresponding to the items of subject data; and
generating a comparison result by comparing the plurality of first feature vectors and the plurality of second feature vectors for each of a plurality of clusters based on the first clustering result.

19. A non-transitory computer-readable storage medium storing a program for causing a computer execute processing comprising:
acquiring a plurality of items of subject data;
training a first training model by performing unsupervised learning on the items of subject data using a first data augmentation condition that is a condition related to a data augmentation conversion method, and generating a plurality of first feature vectors corresponding to the items of subject data;
generating a first clustering result by clustering the plurality of first feature vectors;
training a second training model by performing unsupervised learning on the items of subject data using a second data augmentation condition having a condition regarding the conversion method different from the first data augmentation condition, and generating a plurality of second feature vectors corresponding to the items of subject data; and
generating a comparison result by comparing the plurality of first feature vectors and the plurality of second feature vectors for each of a plurality of clusters based on the first clustering result.
